(19) United States
(12) Patent Application Publication
(10) Pub. No.: US 2018/0009203 A1
(43) Pub. Date: Jan. 11, 2018

(54) MULTI-LAYER FILMS AND METHODS OF MANUFACTURING AND USING THE SAME

(71) Applicant: Coveris Holding Corp., Chicago, IL (US)

(72) Inventors: Joshua Ball, Appleton, WI (US); Solomon O'Neil West, Whitby (CA); Marc Sorem, Appleton, WI (US)

(21) Appl. No.: 15/543,858

(22) PCT Filed: Jan. 15, 2016
(86) PCT No.: PCT/US2016/013706

§ 371 Date: Jul. 14, 2017

Related U.S. Application Data
(60) Provisional application No. 62/151,762, filed on Apr. 23, 2015.
(60) Provisional application No. 62/104,615, filed on Jan. 16, 2015.

(51) Int. Cl. B32B 27/08; B32B 7/12; B32B 27/36; B32B 27/32; B32B 27/34

(52) U.S. Cl. CPC B32B 27/08; B32B 27/32; B32B 27/34; B32B 27/36; B32B 7/12; B32B 2307/518; B32B 2250/24; B32B 2307/584; B32B 2307/7244; B32B 2307/75; B32B 2553/00; B32B 2307/306

(57) ABSTRACT

The present disclosure relates to multi-layer film constructions and methods of manufacturing and using the same. The multi-layer film constructions can include a first layer joined to a second layer. The first layer can include one or more abuse resistant materials. The second layer can include a sealant film, which can be a multi-layer film having one or more sealing layers or sublayers. The second layer can also include one or more barrier layers. The multi-layer film constructions can also include score regions, which can be imparted by a laser or other mechanical implement.

### CROSS-REFERENCE TO RELATED APPLICATIONS

This patent application claims priority to U.S. Patent Application No. 62/104,615 entitled MULTI-LAYER FILMS AND METHODS OF MANUFACTURING AND USING THE SAME, filed on Jan. 16, 2015 and U.S. Patent Application No. 62/151,762 entitled MULTI-LAYER FILMS AND METHODS OF MANUFACTURING AND USING THE SAME, filed on Apr. 23, 2015, both of which are incorporated herein by reference in their entireties.

### TECHNICAL FIELD

The present disclosure relates generally to multi-layer film constructions and methods of manufacturing and using the same. In particular, the present disclosure relates to multi-layer film constructions that have low temperature sealing properties and that may be configured to include easy-open features in a packaging structure made therefrom.

### BRIEF DESCRIPTION OF THE DRAWINGS

The written disclosure herein describes illustrative embodiments that are nonlimiting and non-exhaustive. Reference is made to certain of such illustrative embodiments that are depicted in the figures, in which:

FIG. 1 is a cross-sectional view of a multi-layer film construction, according to an embodiment of the present disclosure.

FIG. 1B is a cross-sectional view of a portion of a multi-layer film construction, according to another embodiment of the present disclosure.

FIG. 2 is a cross-sectional view of a multi-layer film construction, according to another embodiment of the present disclosure.

FIG. 3 is a cross-sectional view of a multi-layer film construction, according to yet another embodiment of the present disclosure.

FIG. 4 is a graph of the seal strength of various film samples, according to an embodiment of the present disclosure.

FIG. 5 is a graph of the gelbo flex testing results of various film samples, according to an embodiment of the present disclosure.

FIG. 6 is a graph of the tear strength of various film samples, according to an embodiment of the present disclosure.

FIG. 7 is a graph of the barrier properties of various film samples, according to an embodiment of the present disclosure.

### DETAILED DESCRIPTION

For the purposes of promoting an understanding of the principles of the disclosure provided herein, reference will now be made to the embodiments illustrated in the drawings and specific language will be used to describe the same. It will be readily understood with the aid of the present disclosure that the components of the embodiments, as generally described and illustrated in the figures herein, could be arranged and designed in a wide variety of different configurations. Thus, the following more detailed description of various embodiments, as represented in the figures, is not intended to limit the scope of the disclosure, but is merely representative of various embodiments. In some cases, well-known structures, materials, or operations are not shown or described in detail. While the various aspects of the embodiments are presented in drawings, the drawings are not necessarily drawn to scale unless specifically indicated.

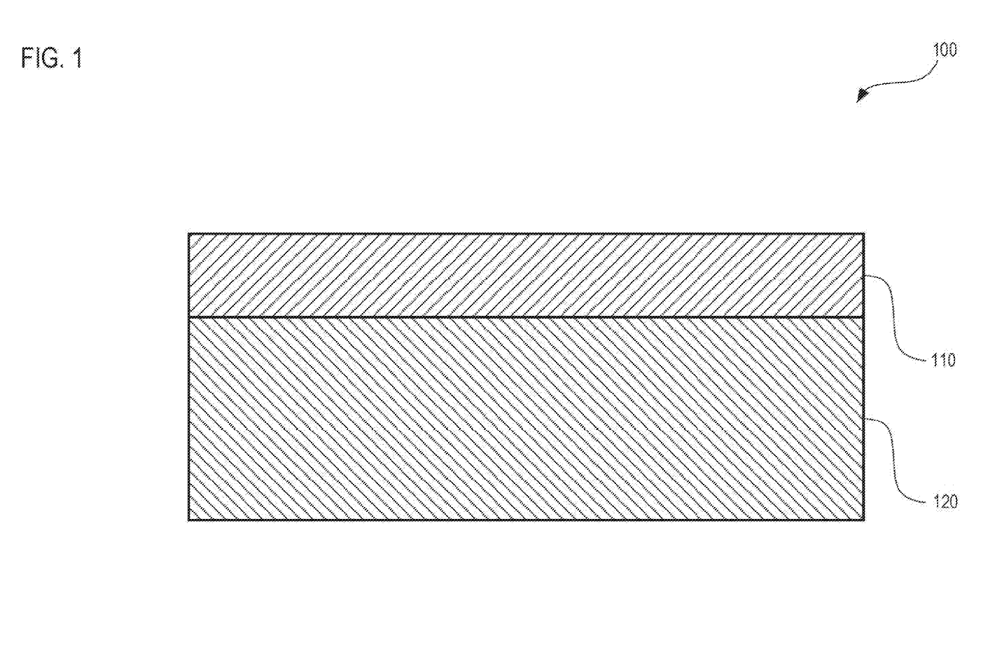

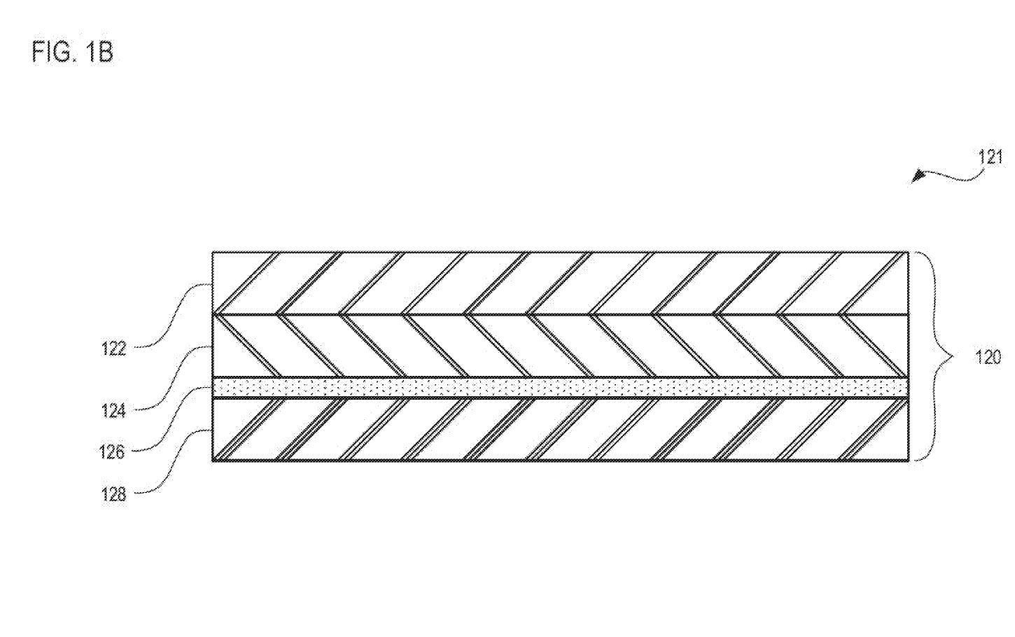

FIG. 1 depicts a multi-layer film or multi-layer film construction 100 according to an embodiment of the present disclosure. As shown in FIG. 1, the multi-layer film 100 can include a first layer 110 and a second layer 120. In certain embodiments, the multi-layer film 100 may include one or more additional layers in addition to the first layer 110 and the second layer 120. For example, one or more additional layers can be disposed on either side or major surface of the first layer 110 and/or on either side or major surface of the second layer 120. One or more additional layers (e.g., a film layer, a tie layer, an adhesive layer, a primer layer, an ink layer, etc.) can also be disposed between the first layer 110 and the second layer 120. Further, in some embodiments the first layer 110, the second layer 120, and/or the one or more additional layers can include or be constructed from a plurality of sublayers (e.g., a multilaminate film layer, a multilaminate tie layer, a multilaminate adhesive layer, etc.), as detailed below.

The first layer 110 may include or be constructed from various materials, including one or more abuse-resistant materials. As can be appreciated, abuse resistant materials can provide, for instance, increased strength and/or impart abuse resistant properties to the first layer 110 and/or the multi-layer film 100. In some embodiments, the first layer 110 is a layer having increased strength and/or abuse resistant properties, and can be referred to as an abuse resistant layer or an abuse resistant film layer. Such abuse resistant properties may include puncture-resistance, tear-resistance, scratch-resistance, grease-resistance, odor-resistance, moisture-resistance, absorption-resistance, and the like. Exemplary materials include, but are not limited to, polymers or copolymers of polyamide (e.g., nylon), polyester (e.g., polyethylene terephthalate (PET)), polypropylene, and derivatives, blends, or combinations thereof. The materials can be oriented (e.g., biaxially oriented), nonoriented, woven, or otherwise configured as desired. For example, in particular embodiments the first layer 110 may include or be constructed from biaxially oriented nylon (BON), biaxially oriented polyamide (BOPA), biaxially oriented polypropylene (BOPP), and/or biaxially oriented polyester (BOPET). Other polymers or copolymers of nylon, polypropylene, and/or polyester can also be used, including derivatives, blends, and/or mixtures thereof.

In addition to providing abuse resistant properties to the multi-layer film 100, the first layer 110 can also be suitable for marking, inscribing, and/or printing indicia thereon, which can be particularly advantageous in embodiments where the first layer 110 is configured to be the outer or outermost layer of a packaging structure.

The first layer 110 can also be capable of being scored. For example, the first layer 110 can be configured to be scored by a thermal process such as laser scoring. The first layer 110 can also be configured to be scored by a mechanical tool or process such as a blade or other mechanical implement. Scoring the first layer 110 with a laser, a blade, or other mechanical implement can impart easy-open characteristics to the multi-layer film 100 or a packaging structure made therefrom, as detailed below.

In some embodiments, the first layer 110 can also be treated with a coating, which can impart one or more properties to the multi-layer film 100. For example, a coating can be used to impart additional abrasion resistance. A coating can also be used to impart an aesthetically appealing gloss finish to the multi-layer film 100, and/or facilitate adhesion and/or bonding of the multi-layer film 100 to other substances or substrates. A coating can also increase, or decrease, the coefficient of friction of the multi-layer film 100. Other known coatings can also be used to impart desired properties to the multi-layer film 100 as desired.

As shown in FIG. 1, the first layer 110 can be joined, attached, laminated, and/or adhered to the second layer 120, which can be performed using various methods and processes, including, but not limited to, lamination and/or extrusion techniques. Exemplary lamination techniques that can be employed include, but are not limited to, extrusion lamination techniques and adhesion lamination techniques. Other known techniques for joining or adhering films can also be used.

One or more tie and/or adhesive materials can also be used to join the first layer 110 and the second layer 120. For example, tie and/or adhesive materials can be co-extruded with, laminated to, or otherwise be disposed between the first layer 110 and the second layer 120. Exemplary tie and/or adhesive materials that can be used include, but are not limited to, solvent-based adhesives, solventless adhesives, plastic type bonding materials, and co-extruded films. Other known tie and/or adhesive materials can also be used. If desired, one or more primers can also be used.

As shown in FIG. 1, the second layer 120 may be a single layer. In one embodiment, the second layer 120 may be a sealant film. The second layer 120 can also include or be constructed with one or more sublayers. For example, as shown in FIG. 1B, in some embodiments the second layer 120 comprises a multi-layer film 121 having a plurality of sublayers 122, 124, 126, 128. In further embodiments, the second layer 120 may be a sealant film having one or more sealing layers or sublayers (e.g., a first sealing sublayer, a second sealing sublayer, etc.). Illustrative multi-layer films 121 that can be used as the second layer 120 include, but are not limited to, multi-layer coextruded blown films, multi-layer laminated films, multi-layer rapid quench blown films, and multi-layer cast films. Other types of multi-layer films 121 can also be used as the second layer 120.

Various polymeric materials can be included in the second layer 120, or one or more sublayers thereof. Exemplary polymeric materials include, but are not limited to, polymers or copolymers of polyethylene (PE), polypropylene (PP), ethylene vinyl alcohol (EVOH), ethylene vinyl acetate (EVA), polyamide (e.g., nylon), and derivatives, blends, and/or combinations thereof. The second layer 120, or one or more sublayers thereof, can also include one or more adhesive and/or tie materials, including but not limited to, polyethylene (PE), modified polyethylene (e.g., maleic anhydride grafted polyethylene), terpolymers (e.g., ethylene containing terpolymers (e.g., ethylene vinyl acetate and maleic anhydride terpolymers, ethylene acrylic ester maleic anhydride terpolymers, etc.)), or derivatives thereof. Other polymers and/or adhesive or tie materials can also be used.

Various forms (e.g., densities) of the polymeric materials can also be used in the second layer 120, or one or more sublayers thereof, including but not limited to low density polyethylene (LDPE), linear low density polyethylene (LLDPE), very low density polyethylene (VLDPE), and blends and/or combinations thereof. In some embodiments, LDPE can have a density range of between about 0.910 g/cm³ and about 0.940 g/cm³, LLDPE can have a density range of between about 0.915 g/cm³ and about 0.925 g/cm³, and VLDPE can have a density range of between about 0.880 g/cm³ and about 0.915 g/cm³. In another embodiment, high density polyethylene (HDPE), having a density greater than about 0.940 g/cm³, may also be used. In other embodiments, however, HDPE is not used.

As previously mentioned, in particular embodiments, the second layer 120 may be sealant film having one or more sealing layers or sublayers. In other words, the second layer 120, or one or more sublayers thereof, can include or be constructed from one or more sealant materials. Sealant materials can provide, for instance, sealing properties and/or sealing functionality to the second layer 120 and/or the multi-layer film 100. Sealant materials include, for instance, materials that may be used or configured to form a seal upon the application of increased pressure and/or heat. Exemplary sealant materials include, but are not limited to, polymers and copolymers of ethylene vinyl acetate (EVA), polyethylene (e.g., LDPE, VLDPE, etc.), and derivatives, blends and/or combinations thereof. For example, in some embodiments, a sealing layer(s) or sublayer(s) can include blends of EVA and VLDPE. And in particular embodiments, a sealing layer(s) or sublayer(s) includes blends of EVA and octene VLDPE.

Further, in additional embodiments, one or more sealing layers or sublayers are fabricated using high weight percent vinyl acetate (VA) content EVA polymers (or blends thereof). For example, one or more sealing layers or sublayers can comprise EVA having greater than about 9% wt. VA, greater than about 10% wt. VA, greater than about 11% wt. VA, greater than about 12% wt. VA, greater than about 13% wt. VA, greater than about 14% wt. VA, greater than about 15% wt. VA, greater than about 16% wt. VA, greater than about 17% wt. VA, greater than about 18% wt. VA, greater than about 19% wt. VA, greater than about 20% wt. VA, greater than about 21% wt. VA, greater than about 22% wt. VA, greater than about 23% wt. VA, greater than about 24% wt. VA, or greater than about 25% wt. VA.

One or more sealing layers or sublayers can also comprise EVA having between about 10% wt. VA and about 30% wt. VA, between about 10% wt. VA and about 25% wt. VA, between about 12% wt. VA and about 23% wt. VA, or between about 15% wt. VA and about 20% wt. VA. EVA comprising a relatively high weight percentage of VA units can yield a second layer 120 and/or multi-layer film 100 having relatively low temperature sealing properties and/or seal caulking characteristics.

In further embodiments, one or more sealing layers or sublayers comprises a material (e.g., polymer material) having a relatively high melt index. As can be appreciated, melt index (M.I.) can be described as the measure of the ease of flow of the melt of a material (such as a thermoplastic polymer material), and can be expressed in units of grams/10 min. In certain embodiments, the melt index is measured according to ASTM D1238 at 190° C. with 2.16 kg loading weight. In some embodiments, for example, one or more sealing layers or sublayers can comprise a material (e.g., EVA) having a melt index of greater than about 5 g/10 min, greater than about 6 g/10 min, greater than about 7 g/10 min, greater than about 8 g/10 min, greater than about 9 g/10 min, greater than about 10 g/10 min, greater than about 11 g/10 min, greater than about 12 g/10 min, greater than about 13 g/10 min, greater than about 14 g/10 min, or greater than about 15 g/10 min. And in particular embodiments, one or more sealing layers or sublayers can comprise a material (e.g., EVA) having a melt index of between about 5 g/10 min and about 15 g/10 min, between about 6 g/10 min and about 12 g/10 min, or between about 7 g/10 min and about 10 g/10 min.

One or more sealing layers or sublayers can also include a material (e.g., polymer material) having a relatively low melt index. For example, one or more sealing layers or sublayers can comprise a material (e.g., EVA, VLDPE, etc.) having a melt index of less than about 3 g/10 min, less than about 2 g/10 min, or less than about 1 g/10 min. One or more sealing layers or sublayers can also comprise a material (e.g., EVA, VLDPE, etc.) having a melt index of between about 0.1 g/10 min and about 3 g/10 min, between about 0.1 g/10 min and about 2 g/10 min, or between about 0.1 g/10 min and about 1 g/10 min.

One or more sealing layers or sublayers can also comprise a blend of materials (e.g., polymer materials) having relatively high (e.g., greater than about 5 g/10 min) and relatively low melt indexes (e.g., less than about 2 g/10 min). For example, one or more sealing layers or sublayers can comprise a blend of at least one material (e.g., EVA) having any of the above-mentioned relatively high melt indexes (e.g., greater than about 5 g/10 min), and at least one material (e.g., EVA, VLDPE, etc.) having any of the above-mentioned relatively low melt indexes (e.g., less than about 2 g/10 min). Such blends can be advantageous in obtaining desired sealing properties for the multi-layer film 100.

In particular blends, for example, the amount of material having a relatively high melt index is greater than about 35%, greater than about 40%, greater than about 45%, or greater than about 50% of the total weight of the blend. And in some embodiments, the amount of material having a relatively low melt index is less than about 55%, less than about 50%, less than about 45%, or less than about 40% of the total weight of the blend. Further, in certain embodiments, the blend comprises between about 35% wt. and about 70% wt. of material having a relatively high melt index, and between about 30% wt. and about 65% wt. of material having a relatively low melt index. In other embodiments, the blend comprises between about 40% wt. and about 70% wt. of material having a relatively high melt index, and between about 30% wt. and about 60% wt. of material having a relatively low melt index. In yet other embodiments, the blend comprises between about 45% wt. and about 70% wt. of material having a relatively high melt index, and between about 30% wt. and about 55% wt. of material having a relatively low melt index. And in yet other embodiments, the blend comprises between about 45% wt. and about 65% wt. of material having a relatively high melt index, and between about 35% wt. and about 55% wt. of material having a relatively low melt index.

The second layer 120 can also include one or more sealing layers or sublayers comprising a material (e.g., EVA) having a relatively high melt index (e.g., greater than about 5 g/10 min), and one or more sealing layers or sublayers comprising a material (e.g., EVA, VLDPE, etc.) having a relatively low melt index (e.g., lower than about 2 g/10 min). For example, an innermost layer of the second layer 120, such as sublayer 128 of FIG. 1B, can include a sealing layer or sublayer comprising a material (e.g., EVA) having a relatively high melt index (e.g., greater than about 5 g/10 min), and an adjacent layer or sublayer, such as sublayer 126 of

FIG. 1B, can comprise a material (e.g., EVA, VLDPE, etc.) having a relatively low melt index (e.g., lower than about 2 g/10 min). Arranging such sealing layers adjacent to one another can also aid in obtaining desired sealing properties for the multi-layer film 100.

The second layer 120 can also include one or more barrier materials which can server as a barrier to elements such as grease, moisture, liquids, gases (e.g., oxygen, water or moisture vapor, etc.), or combinations thereof. The barrier materials can also be included in a barrier layer, which can be a sublayer of the second layer 120, as detailed below. Exemplary barrier materials include, but are not limited to, polymers or copolymers of polyamide (e.g., nylon), PET, EVOH, or derivatives, blends, and/or combinations thereof. Other known barrier materials can also be used. For example, a barrier coating can be applied to provide barrier properties to the multi-layer film 100.

In some embodiments, the multi-layer film 100 can be configured to exhibit particular barrier or permeability properties, which can be represented by the film's oxygen transmission rate (OTR). The OTR is a measurement of the amount of oxygen gas that passes through a film over a given period of time. In some embodiments, the OTR of the multi-layer film 100 is less than about 1.5 cc/100in²/day at 85% relative humidity and 73° F. In other embodiments, the OTR of the multi-layer film 100 is less than about 1.3 cc/100in²/day at 85% relative humidity and 73° F. In further embodiments, the OTR of the multi-layer film 100 is less than about 1.2 cc/100in²/day at 85% relative humidity and 73° F. In yet other embodiments, the OTR of the multi-layer film 100 is less than about 1.1 cc/100in²/day at 85% relative humidity and 73° F., or less than about 1.0 cc/100in²/day at 85% relative humidity and 73° F.

The barrier properties or permeability of the multi-layer film 100 can also be represented by the moisture vapor transmission rate (MVTR). The MVTR is a measurement of the amount of moisture or water vapor (H₂O gas) that passes through a film over a given period of time. In certain embodiments, the MVTR of the multi-layer film 100 is less than about 1.0 g/100in²/day at 85% relative humidity and 73° F., or less than about 0.9 g/100in²/day at 85% relative humidity and 73° F. In some embodiments, the MVTR of the multi-layer film 100 is less than about 0.8 g/100in²/day at 85% relative humidity and 73° F. In other embodiments, the MVTR of the multi-layer film 100 is less than about 0.75 g/100in²/day at 85% relative humidity and 73° F. In yet other embodiments, the MVTR of the multi-layer film 100 is less than about 0.7 g/100in²/day at 85% relative humidity and 73° F. In further embodiments, the moisture vapor transmission rate of the multi-layer film 100 is less than about 0.65 g/100in²/day at 85% relative humidity and 73° F.

The multi-layer film 100 can also be configured to exhibit neutral organoleptic properties. For example, in some embodiments, the multi-layer film 100 does not substantially affect the flavor or odor of a product packaged within the multi-layer film 100. More specifically, in some embodiments, the multi-layer film 100 does not substantially add to the flavor or odor of a product. In further embodiments the multilayer film 100 does not substantially absorb or otherwise remove flavor or odor from a product. In particular embodiments, the product is an edible, food, and/or beverage product. In one embodiment, the product is a product suitable for human consumption.

The thickness of the multi-layer film 100 can vary as desired. For example, in some embodiments, the multi-layer film 100 may have a total thickness of between about 2.0 mils and about 4.0 mils. In other embodiments, the multi-layer film 100 has a thickness of between about 2.25 mils and about 3.75 mils, or between about 2.5 mils and about 3.5 mils. In yet other embodiments, the thickness of the multi-layer film 100 is between about 2.8 mils and about 3.2 mils. Further, the thickness of the first layer 110 can be between about 1.0 mils and about 2.0 mils, or between about 1.25 mils and about 1.75 mils, and the thickness of the second layer 120 can be between about 1.5 mils and about 2.5 mils, or between about 1.75 mils and about 2.0 mils. Other thicknesses can also be used.

If desired, the multi-layer film 100 (or any layer 110, 120, additional layer, or sublayer thereof) can further comprise one or more additional known materials that add strength, stiffness, heat resistance, durability, printability, and/or other enhanced characteristics to the multi-layer film 100. Additionally, one or more known film additives may be added to the multi-layer film 100 (or any layer 110, 120, additional layer, or sublayer thereof), such as slip agents, anti-blocking agents, colorants, odor inhibitors, oxygen inhibitors, and the like.

The multi-layer film 100 can also be used for various purposes. For example, the multi-layer film 100 can be wrapped, folded, configured, or otherwise used to manufacture a packaging structure. In certain embodiments, the multi-layer film 100 can be used in flow wrapper or flow wrapping applications. When used in flow wrapping applications, the multi-layer film 100 can be wrapped such that the first layer 110 is oriented or otherwise directed toward the outside of the packaging structure relative to the second layer 120, and the second layer 120 is oriented or otherwise directed toward the inside of the packaging structure relative to the first layer 110 (e.g., toward the cavity within the packaging structure, or toward the contents of the packaging structure). In such embodiments, the first layer 110 can be described as an outer layer, and the second layer 120 can be described as an inner layer.

The packaging structure formed by the multi-layer film 100 can also be sealed. For example, the packaging structure can include one or more seals (e.g., a fin seal) running the length of the packaging structure, and one or more seals (e.g., a crimp seal) at the top and/or the bottom of the packaging structure. In some embodiments, seals (e.g., fin seals and crimp seals) can be formed by aligning an inner surface of a first portion of the second layer 120 with an inner surface of a second portion of the second layer 120, and joining the inner surfaces together by applying increased pressure and/or temperature.

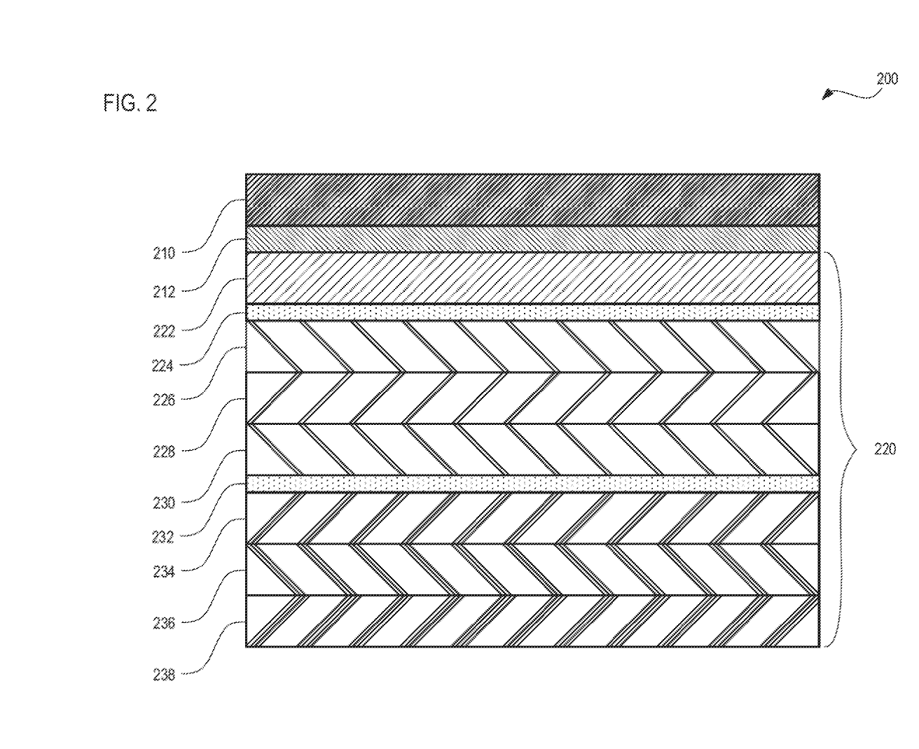

FIG. 2 depicts a multi-layer film 200 according to another embodiment of the present disclosure. The multi-layer film 200 can, in certain respects, resemble components of the multi-layer film 100 described in connection with FIG. 1 above. It will be appreciated that all the illustrated embodiments may have analogous features. Accordingly, like features are designated with like reference numerals, with the leading digits incremented to “2.” (For instance, the multi-layer film is designated “100” in FIG. 1, and an analogous multi-layer film is designated as “200” in FIG. 2.) Relevant disclosure set forth above regarding similarly identified features thus may not be repeated hereafter. Moreover, specific features of the multi-layer film 200 and related components shown in FIG. 2 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the film construction 200 of FIG. 2. Any suitable combination of the features, and variations of the same, described with respect to the multi-layer film 100 and components illustrated in FIG. 1, can be employed with the multi-layer film 200 and components of FIG. 2, and vice versa. This pattern of disclosure applies equally to further embodiments depicted in subsequent figures and described hereafter.

Shown in FIG. 2 is a multi-layer film construction 200 having a first layer 210 and a second layer 220, which are joined using an intermediate layer 212, such as a tie layer or an adhesive layer. Further, in the illustrated embodiment, the second layer 220 includes and is constructed using nine sublayers. As can be appreciated, additional or fewer sublayers can also be used to construct the second layer 220.

Each of the various sublayers 222, 224, 226, 228, 230, 232, 234, 236, 238 can impart one or more properties to the multi-layer film 200. For example, in some embodiments, one or more barrier layers can be included as one or more sublayers in the second layer 220, each of which can comprise any one or more of the above-mentioned barrier materials. In some embodiments, the one or more barrier layers can also be sandwiched (or encapsulated) by polyamide layers. One or more sealant layers can also be included as one or more sublayers in the second layer 220, each of which can comprise any one or more of the above-mentioned sealant materials. Tie and/or adhesive layers can also be used for joining one or more sublayers together.

For example, in a particular embodiment, the second layer 220 comprises a first sublayer 222 comprising polyethylene or a blend thereof (e.g., a blend of LLDPE (e.g., octene LLDPE) and LDPE), a second sublayer 224 comprising an adhesive tie material, a third sublayer 226 comprising a polyamide (e.g., nylon), a fourth sublayer 228 comprising a barrier material (e.g., EVOH), a fifth sublayer 230 comprising a polyamide (e.g., nylon), a sixth sublayer 232 comprising an adhesive tie material, a seventh sublayer 234 comprising polyethylene or a blend thereof (e.g., octene VLDPE), an eighth sublayer 236 comprising a sealant material such as EVA or a blend thereof (e.g., a blend of EVA and polyethylene (e.g., octene VLDPE)), and a ninth sublayer 238 comprising a sealant material such as EVA or a blend thereof (e.g., a blend of EVA and polyethylene (e.g., octene VLDPE)).

In yet another particular embodiment, the second layer 220 comprises a first sublayer 222 comprising polyethylene or a blend thereof (e.g., a blend of LLDPE (e.g., octene LLDPE) and LDPE), a second sublayer 224 comprising polyethylene (e.g., LDPE), a third sublayer 226 comprising an adhesive tie material, a fourth sublayer 228 comprising a barrier material (e.g., EVOH), a fifth sublayer 230 comprising an adhesive tie material, a sixth sublayer 232 comprising polyethylene (e.g., LDPE), a seventh sublayer 234 comprising polyethylene (e.g., octene VLDPE), an eighth sublayer 236 comprising a sealant material such as EVA or a blend thereof (e.g., a blend of EVA and polyethylene (e.g., octene VLDPE)), and a ninth sublayer 238 comprising a sealant material such as EVA or a blend thereof.

As further shown in FIG. 2, one or more sealant layers 236, 238 can be disposed at a position that is furthest away from the first layer 210. In such embodiments, the one or more sealant layers 236, 238 can be described as the innermost layers of the second layer 220, or the innermost layers of the multi-layer film 200. If desired, one or more portions of the sealant layers 236, 238 can be configured to be sealed to itself, or to another layer or sublayer of the multi-layer film 200. For example, the multi-layer film 200 can be wrapped or folded and formed into a packaging structure with the sealant layers 236, 238 being disposed closest or proximal to the cavity or the contents thereof. The sealant layers 236, 238 can then be aligned with themselves, or with another layer or sublayer, and sealed by the application of increased pressure and/or temperature (e.g., to form a fin or crimp seal).

In certain embodiments, the multi-layer film 200 exhibits relatively low temperature sealing properties. For example, in some embodiments, the seal initiation temperature is reached at or below about 200° F. (at 40 PSI, 0.5 seconds). In such embodiments, the seal strength of the multi-layer film 200 can be greater than about 1 lb/in, greater than about 1.5 lbs/in, greater than about 2 lbs/in, greater than about 2.5 lbs/in, or greater than about 3 lbs/in at 200° F. (at 40 PSI, 0.5 seconds). The peak seal strength can also be reached at about 240° F. (at 40 PSI, 0.5 seconds). For example, the seal strength of the multi-layer film 200 can be greater than about 5 lbs/in, greater than about 5.5 lbs/in, greater than about 6 lbs/in, or greater than about 6.5 lbs/in at 240° F. (at 40 PSI, 0.5 seconds).

Further, in some embodiments, the innermost sublayer (e.g., the ninth sublayer 238) comprises a sealant material having a relatively high melt index. The ninth sublayer 238 can also comprise a blend of sealant materials, including a first sealant material having a relatively high melt index and a second material having a relatively low melt index. Such blends can increase the sealing characteristics of the multi-layer film 200. And in particular embodiments, the eighth sublayer 236 can include one or more sealant materials having a relatively low melt index.

The sealant layers or sublayers 236, 238 can also make up a relatively large weight percentage of the second layer 220. For example, in some embodiments, the second layer 220 comprises at least about 15% wt., at least about 20% wt., at least about 25% wt., at least about 30% wt., at least about 35% wt., at least about 40% wt., at least about 45% wt., or at least about 50% wt. of sealant materials. In other words, the sealant layers or sublayers 236, 238 can be at least about 15% wt., at least about 20% wt., at least about 25% wt., at least about 30% wt., at least about 35% wt., at least about 40% wt., at least about 45% wt., or at least about 50% wt. of the second layer 220.

The second layer 220, including each of the sublayers 222, 224, 226, 228, 230, 232, 234, 236, 238 thereof, can be formed in various ways. For example, each of the sublayers 222, 224, 226, 228, 230, 232, 234, 236, 238 can be simultaneously coextruded and blown using coextruded blown film forming techniques to fabricate a multi-layer coextruded blown film. Coextruded blown film forming techniques can be advantageous in many ways. For example, coextruded blown film forming techniques can be more economical (cost less) and more efficient (faster) than other film forming techniques. Multi-layer rapid quench blown film techniques, multi-layer cast film techniques, and other known techniques can also be used.

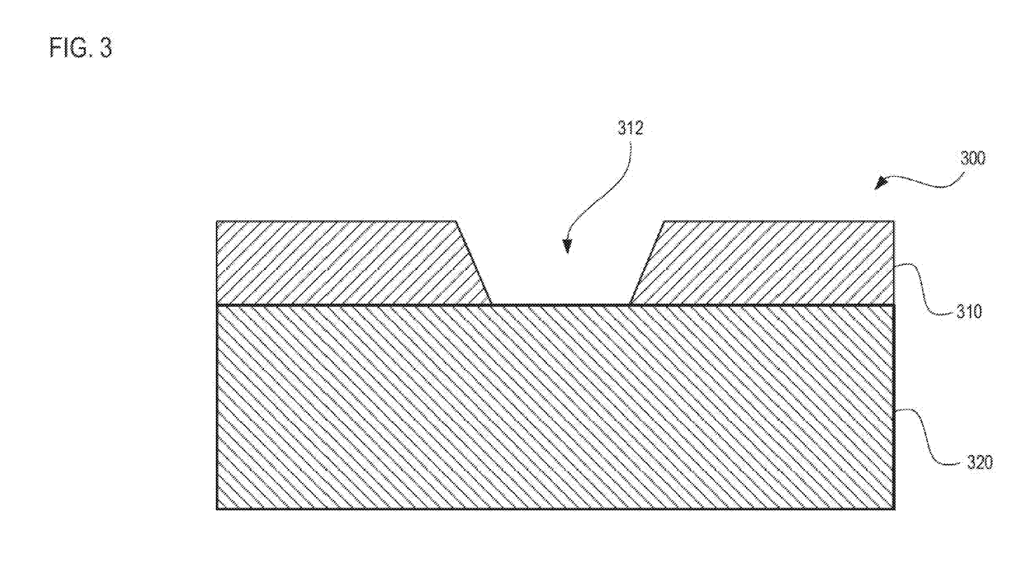

FIG. 3 depicts a multi-layer film 300 according to another embodiment of the present disclosure. Shown in FIG. 3 is a multi-layer film 300 having a first layer 310 and a second layer 320. The multi-layer film 300 further comprises one or more score regions 312. As previously discussed, the score regions 312 can be imparted with a laser, a blade, or other mechanical implement.

The score region 312 can provide the multi-layer film 300 with an area of weakened material along which the multi-layer film 300 can be torn or otherwise opened. For example, the score region 312 can comprise an area wherein at least part of the multi-layer film 300 (or a layer 310 thereof) is removed. In some of such embodiments, the score region 312 reduces the amount of force needed to propagate a tear when opening.

The score region 312 can also aid in controlled tearing or otherwise opening of the multi-layer film 300. For example, the score region 312 can provide a guide on which the multi-layer film 300 can tear along during opening. The likelihood of tearing the multi-layer film 300 outside the score region 312 area can be reduced, preventing the tear from wandering to an area in the body of the multi-layer film 300 or packaging structure made therefrom. The likelihood of incomplete tearing or opening of the multilayer film 300 can also be reduced.

The score region 312 may be continuous or discontinuous (e.g., dashed). For example, a continuous laser beam may be used to create a continuous score region 312 on the multi-layer film 300, and a discontinuous laser beam (e.g., a pulsed beam) can be used to create a discontinuous, perforated, or dashed score region 312 on the multi-layer film 300.

With continued reference to FIG. 3, the score region 312 can extend at least partially, or completely, through one or more layers 310, 320 of the multi-layer film 300. For example, the score region 312 can extend partially, or completely, through the first layer 310 of the multi-layer film 300. Further, in particular embodiments, a laser used to impart a score region 312 can be focused and tuned such that only the first layer 310 of the multi-layer film 300 is affected, and the second layer 320 (including any sublayers) can remain substantially unaffected, as shown in FIG. 3. In such particular embodiments, the properties of the second layer 320, including any barrier and/or sealant layers, can remain substantially unaffected and unchanged. For example, the oxygen and/or moisture vapor transmission rate of the second layer 320 and/or the multi-layer film 300 can remain substantially unaffected by the score region 312. In yet other embodiments, the score region 312 can extend partially, or completely, through the first layer 310 and the second layer 320 of the multi-layer film 300.

Methods of manufacturing multi-layer films are also disclosed herein. In particular, it is contemplated that any of the components, principles, and/or embodiments discussed above may be utilized in either a multi-layer film construction or a method of manufacturing and using the same. For example, in an embodiment, a method of manufacturing a multi-layer film construction can comprise a step of coextruding a plurality of polymeric materials and blowing the coextruded polymeric materials to form a multi-layer coextruded blown film layer. As disclosed above, the resulting multi-layer coextruded blown film layer can comprise one or more barrier layers and one or more sealant layers. The method can further comprise a step of laminating the multi-layer coextruded blown film layer to an abuse resistant layer comprising at least one of a polyester, polypropylene, or polyamide polymer or copolymer. In some embodiments, laminating the multi-layer coextruded blown film layer to the abuse resistant layer comprises extrusion lamination with an intermediate layer, such as a tie layer. In other embodiments, the multi-layer coextruded blown film layer is laminated to the abuse resistant layer with an intermediate layer, such as an adhesive layer. In further embodiments, the method can also comprise a step of imparting a score region to a surface of the abuse resistant layer using a laser, a blade, or other mechanical implement. Additional processing steps, and/or methods, can also be employed.

It will be obvious to those having skill in the art that many changes may be made to the details of the above-described embodiments without departing from the underlying principles of the invention. The scope of the present invention should, therefore, be determined only by the following claims.

### EXAMPLES

The following examples are illustrative of embodiments of the present disclosure, as described above, and are not meant to be limiting in any way.

Six multi-layer film samples were prepared as follows:

Sample 1: A first multi-layer film sample was prepared by laminating a first layer to a second layer using a LDPE tie layer. The first layer comprised biaxially oriented polyester (BOPET) (36 gauge), and the second layer comprised the nine-layer coextruded blown film (175 gauge total) described in the table below, with the 1st sublayer being disposed closest to the biaxially oriented polyester layer and the 9th sublayer being disposed furthest away from the biaxially oriented polyester layer.

| Structure | Percent by Weight of | Materials and Percent by |
|---|---|---|
| Sublayer | Structure (Wt %) | Weight of Structure Layer |
| 1 | 20 | 68% LLDPE |
| | | 30% LDPE |
| | | 2% Slip and Anti-Block Additives |
| 2 | 6 | Adhesive Tie |
| 3 | 6 | Polyamide |
| 4 | 8 | EVOH |
| 5 | 6 | Polyamide |
| 6 | 6 | Adhesive Tie |
| 7 | 18 | VLDPE |
| 8 | 15 | 50% EVA (12% wt. VA) |
| | | (0.35 g/10 min M.I.) |
| | | 48% VLDPE (0.90 g/10 min M.I.) |
| | | 2% Slip Additives |
| 9 | 15 | 52% EVA (18% wt. VA) |
| | | (8.0 g/10 min M.I.) |
| | | 37.5% EVA (18% wt. VA) |
| | | (0.70 g/10 min M.I.) |
| | | 10.5% Slip and Anti-Block Additives |

Sample 2: A second multi-layer film sample was prepared by laminating a first layer to a second layer using a LDPE tie layer. The first layer comprised biaxially oriented polyester (BOPET) (36 gauge), and the second layer comprised the nine-layer coextruded blown film (175 gauge total) described in the table below, with the 1st sublayer being disposed closest to the biaxially oriented polyester layer and the 9th sublayer being disposed furthest away from the biaxially oriented polyester layer.

| Structure | Percent by Weight of | Materials and Percent by |
|---|---|---|
| Sublayer | Structure (Wt %) | Weight of Structure Layer |
| 1 | 20 | 68% LLDPE |
| | | 30% LDPE |
| | | 2% Slip and Anti-Block Additives |
| 2 | 6 | Adhesive Tie |
| 3 | 6 | Polyamide |
| 4 | 8 | EVOH |
| 5 | 6 | Polyamide |
| 6 | 6 | Adhesive Tie |
| 7 | 18 | VLDPE |
| 8 | 15 | 60% EVA (12% wt. VA) |
| | | (0.35 g/10 min M.I.) |
| | | 38% VLDPE (0.90 g/10 min M.I.) |
| | | 2% Slip Additives |
| 9 | 15 | 52% EVA (18% wt. VA) |
| | | (8.0 g/10 min M.I.) |
| | | 37.5% EVA (18% wt. VA) |
| | | (0.70 g/10 min M.I.) |
| | | 10.5% Slip and Anti-Block Additives |

Sample 3: A third multi-layer film sample was prepared by laminating a first layer to a second layer using a LDPE tie layer. The first layer comprised biaxially oriented polyester (BOPET) (36 gauge), and the second layer comprised the nine-layer coextruded blown film (175 gauge total) described in the table below, with the 1st sublayer being disposed closest to the biaxially oriented polyester layer and the 9th sublayer being disposed furthest away from the biaxially oriented polyester layer.

| Structure | Percent by Weight of | Materials and Percent by |
|---|---|---|
| Sublayer | Structure (Wt %) | Weight of Structure Layer |
| 1 | 20 | 68% LLDPE |
| | | 30% LDPE |
| | | 2% Slip and Anti-Block Additives |
| 2 | 6 | Adhesive Tie |
| 3 | 6 | Polyamide |
| 4 | 8 | EVOH |
| 5 | 6 | Polyamide |
| 6 | 6 | Adhesive Tie |
| 7 | 18 | VLDPE |
| 8 | 15 | 60% EVA (12% wt. VA) |
| | | (0.35 g/10 min M.I.) |
| | | 38% VLDPE (0.90 g/10 min M.I.) |
| | | 2% Slip Additives |
| 9 | 15 | 52% EVA (18% wt. VA) |
| | | (8.0 g/10 min M.I.) |
| | | 37.5% VLDPE |
| | | (0.90 g/10 min M.I.) |
| | | 10.5% Slip and Anti-Block Additives |

Sample 4: A fourth multi-layer film sample was prepared by laminating a first layer to a second layer using an adhesive layer. The first layer comprised biaxially oriented nylon (BON) (48 gauge), and the second layer comprised the nine-layer coextruded blown film (225 gauge total) described in the table below, with the 1st sublayer being disposed closest to the biaxially oriented nylon layer and the 9th sublayer being disposed furthest away from the biaxially oriented nylon layer.

| Structure | Percent by Weight of | Materials and Percent by |
|---|---|---|
| Sublayer | Structure (Wt %) | Weight of Structure Layer |
| 1 | 17 | 64% LLDPE |
| | | 28% LDPE |
| | | 8% Slip and Anti-Block Additives |
| 2 | 12 | LDPE |
| 3 | 6 | Adhesive Tie |
| 4 | 8 | EVOH |
| 5 | 6 | Adhesive Tie |
| 6 | 6 | LDPE |
| 7 | 15 | VLDPE |
| 8 | 15 | 60% EVA (12% wt. VA) |
| | | (0.35 g/10 min M.I.) |
| | | 38% VLDPE (0.90 g/10 min M.I.) |
| | | 2% Slip Additives |
| 9 | 15 | 56% EVA (18% wt. VA) |
| | | (8.0 g/10 min M.I.) |
| | | 37.5% EVA (18% wt. VA) |
| | | (0.70 g/10 min M.I.) |
| | | 6.5% Slip and Anti-Block Additives |

Comparison Sample 1: A first comparison sample was prepared from a commercially available film comprising the following structure: biaxially oriented polyester (BOPET) (36 gauge) ethylene vinyl alcohol (EVOH)/biaxially oriented polypropylene (BOPP) (55 gauge)/ethylene vinyl acetate (EVA). In contrast to Samples 1-4, the EVA layer in this commercially available film was extrusion coated onto the BOPP layer rather than coextruded and blown.

Comparison Sample 2: A second comparison sample was prepared from a commercially available film comprising the following structure: biaxially oriented nylon (BON) (48 gauge)/ethylene vinyl alcohol (EVOH)/biaxially oriented polypropylene (BOPP) (55 gauge/ethylene vinyl adetate (EVA). In contrast to Samples 1-4, the EVA layer in this commercially available film was extrusion coated onto the BOPP layer rather than coextruded and blown.

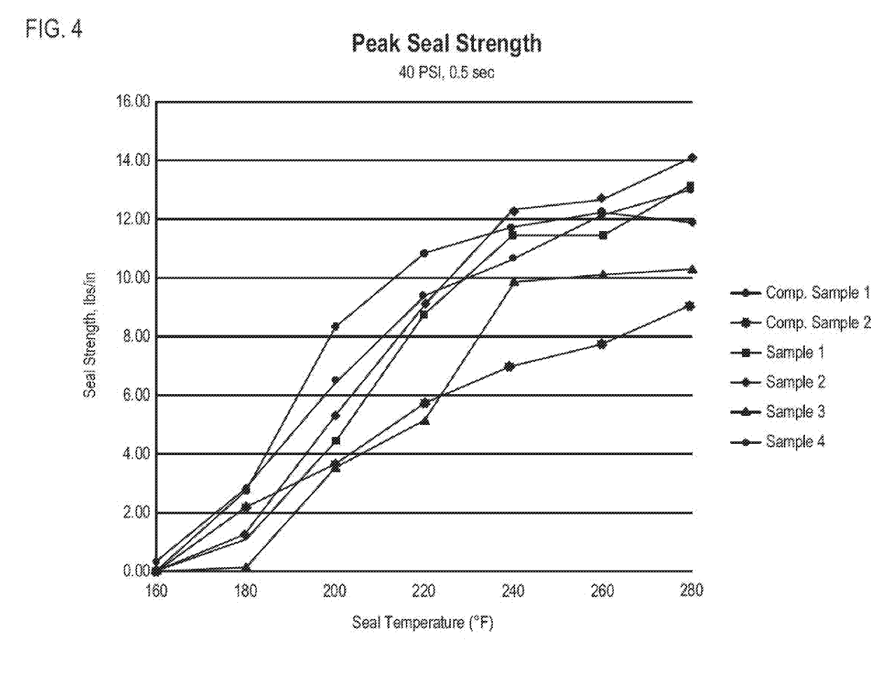

Various properties of the samples were then measured, including the peak seal strength, Gelbo @ 38° F., tear strength, and barrier properties, the results of which are shown in FIGS. 4-7, respectively.

As shown in FIG. 4, Samples 1-4 exhibited acceptable seal strengths, which were comparable to the seal strengths of Comparison Samples 1-2. For example, the seal strength for each of Samples 1-4 was greater than about 2 lbs/in at 200° F. (40 PSI, 0.5 sec). Further, the seal strength for each of Samples 1-4 was greater than about 6 lbs/in at 240° F. (40 PSI, 0.5 sec).

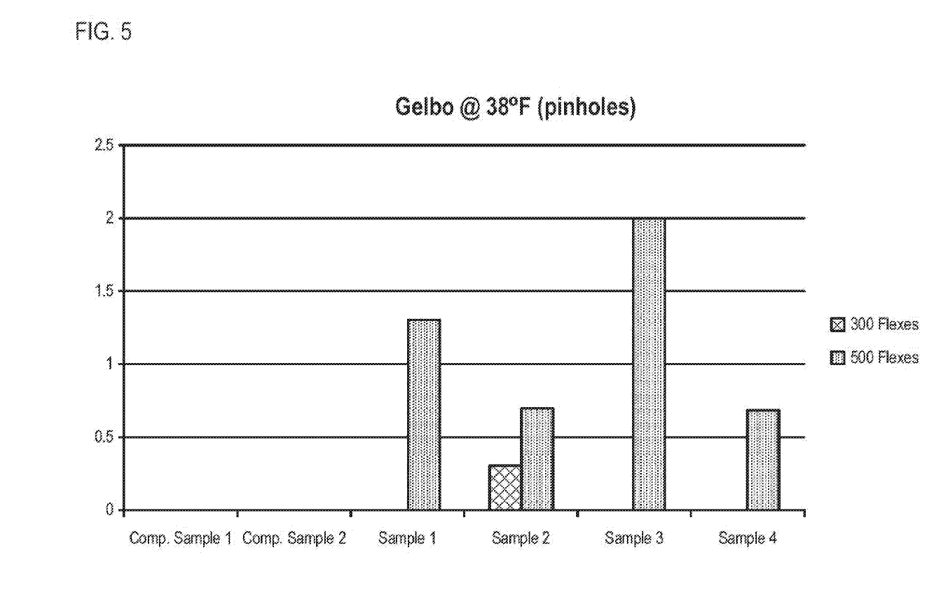

As shown in FIG. 5, Samples 1-4 also exhibited acceptable results when subjected to the Gelbo @ 38° F. pinhole test. For example, each of Samples 1-4 exhibited fewer than two pinholes (and more specifically, fewer than one pinhole) after 300 flexes, with several Samples exhibiting 0 pinholes after 300 flexes. Each of Samples 1-4 also exhibited fewer than five pinholes (and more specifically, fewer than three pinholes) after 500 flexes.

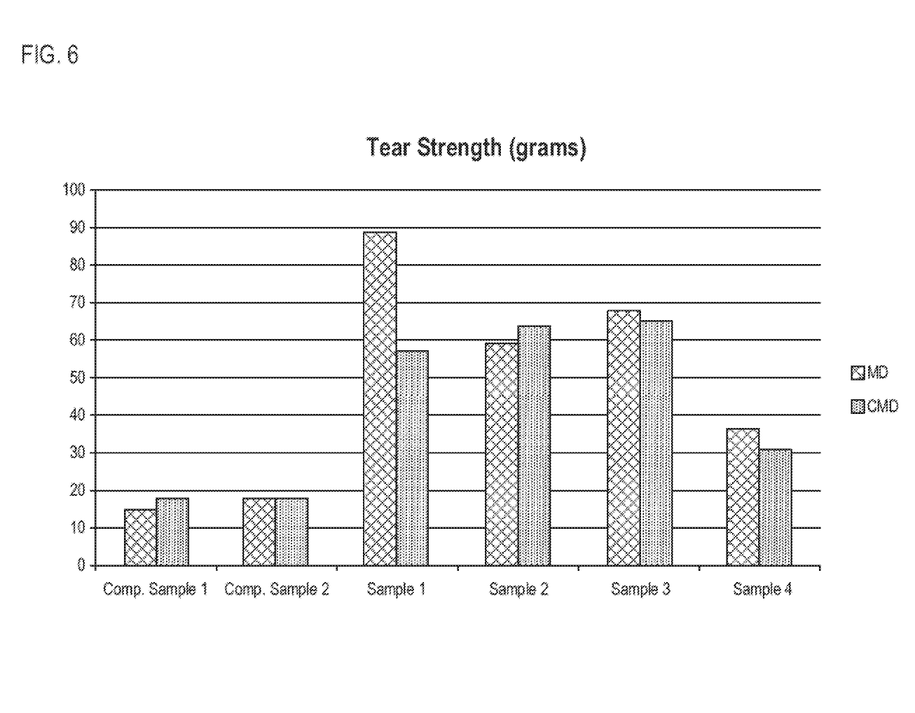

As shown in FIG. 6, Samples 1-4 also exhibited acceptable tear strengths. For example, the tear strength in the machine direction (MD) for each of Samples 1-4 was less than 100 grams, and the tear strength in the cross machine direction (CMD) for each of Samples 1-4 was also less than 100 grams.

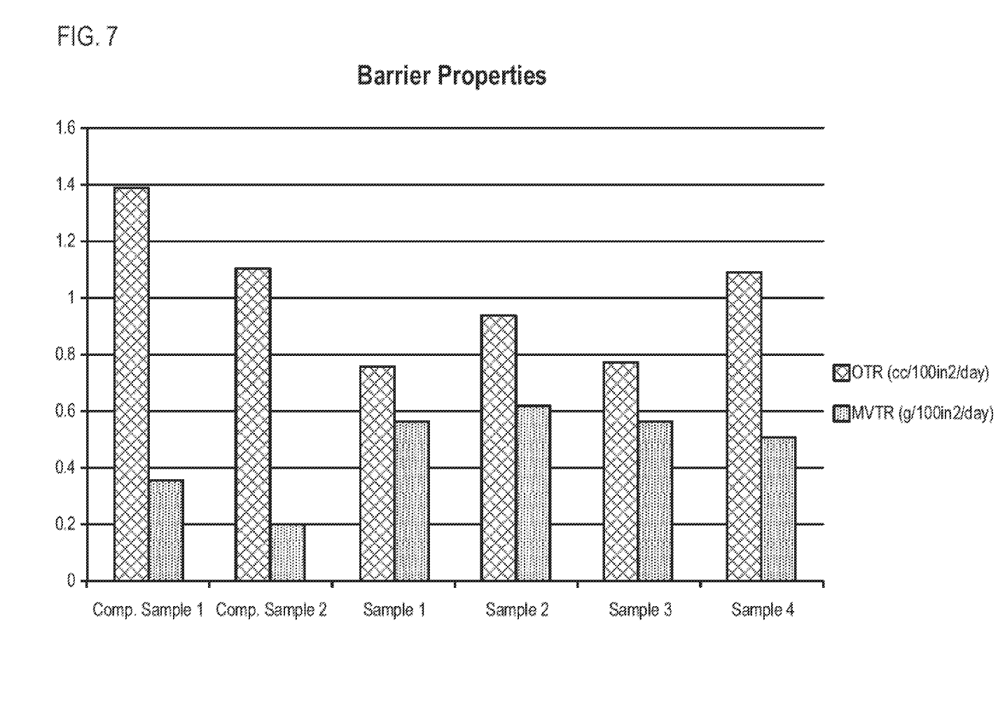

As shown in FIG. 7, Samples 1-4 also exhibited acceptable barrier properties. For example, the OTR for each of Samples 1-4 was less than about 1.5 cc/100in²/day at 85% relative humidity and 73° F., and the MVTR for each of Samples 1-4 was less than about 1.00 g/100in²/day at 85% relative humidity and 73° F.

Throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. The scope of the invention is therefore defined by the following claims and their equivalents.

1. A multi-layer film construction, comprising:
a first layer comprising at least one of a polyester, polyamide, or polypropylene; and
a second layer comprising a plurality of sublayers, wherein at least one sublayer comprises a barrier layer and at least one sublayer comprises a sealant layer, wherein the sealant layer comprises a material having a melt index of between about 5 g/1 0 min and about 15 g/1 0 min, between about 6 g/1 0 min and about 12 g/1 0 min, or between about 7 g/1 0 min and about 10 g/1 0 min.

2. The multi-layer film construction of claim 1, wherein the sealant layer further comprises a second material having a melt index of between about 0.1 g/10 min and about 3 g/10 min, between about 0.1 g/10 min and about 2 g/10 min, or between about 0.1 g/10 min and about 1 g/10 min.

3. The multi-layer film construction of claim 1, wherein the second layer further comprises a second sealant layer comprising a material having a melt index of between about 0.1 g/10 min and about 3 g/10 min, between about 0.1 g/10 min and about 2 g/10 min, or between about 0.1 g/10 min and about 1 g/10 min.

4. The multi-layer film construction of claim 1, wherein the sealant layer comprises ethylene vinyl acetate.

5. The multi-layer film construction of claim 1, wherein the sealant layer comprises ethylene vinyl acetate comprising between about 10% wt. and about 25% wt. vinyl acetate units.

6. The multi-layer film construction of claim 5, wherein the sealant layer comprises ethylene vinyl acetate comprising between about 15% wt. and about 20% wt. vinyl acetate units.

7. The multi-layer film construction of claim 1, wherein the first layer comprises at least one of biaxially oriented polyester or biaxially oriented nylon.

8. The multi-layer film construction of claim 1, wherein the barrier layer comprises ethylene vinyl alcohol.

9. The multi-layer film construction of claim 1, wherein the barrier layer is disposed between polyamide or adhesive layers.

10. The multi-layer film construction of claim 1, further comprising a scored region that extends through at least a portion of the first layer.

11. The multi-layer film construction of claim 1, wherein the multi-layer film construction comprises a seal strength of greater than about 5 lbs/in at a seal temperature of about 240° F. at 40 PSI at 0.5 seconds.

12. The multi-layer film construction of claim 1, wherein the multi-layer film construction comprises an oxygen transmission rate of less than 1.5 cc/100 in²/day at 85% relative humidity and 73° F.

13. The multi-layer film construction of claim 1, wherein the multi-layer film construction comprises a moisture vapor transmission rate of less than 1.0 g/100 in²/day at 85% relative humidity and 73° F.

14. The multi-layer film construction of claim 1, wherein the second layer comprises a nine-layer film.

15. The multi-layer film construction of claim 1, wherein the thickness of the multi-layer film construction is between about 2.0 mils and about 4.0 mils.

16. A method of manufacturing a multi-layer film construction, comprising:
coextruding a plurality of polymeric materials and blowing the coextruded materials to form a multi-layer coextruded blown film layer comprising a barrier layer and a sealant layer, the sealant layer comprising a material having a melt index of between about 5 g/10 min and about 15 g/10 min, between about 6 g/10 min and about 12 g/10 min, or between about 7 g/10 min and about 10 g/10 min; and
joining the multi-layer coextruded blown film layer to a second layer comprising at least one of a polyester, polyamide, or polypropylene.

17. The method of claim 16, wherein the sealant layer comprises ethylene vinyl acetate.

18. The method of claim 16, wherein the sealant layer further comprises a second material having a melt index of between about 0.1 g/10 min and about 3 g/10 min, between about 0.1 g/10 min and about 2 g/10 min, or between about 0.1 g/10 min and about 1 g/10 min.

19. The method of claim 16, wherein the multi-layer coextruded blown film layer further comprises a second sealant layer comprising a material having a melt index of between about 0.1 g/10 min and about 3 g/10 min, between about 0.1 g/10 min and about 2 g/10 min, or between about 0.1 g/10 min and about 1 g/10 min.

20. The method of claim 16, further comprising: imparting a score region to a surface of the second layer such that the score region does not extend into the multi-layer coextruded blown film layer.
